(19) United States
(12) Patent Application Publication
(10) Pub. No.: US 2012/0306612 A1
(43) Pub. Date: Dec. 6, 2012

(54) Electric Line Interface System

(75) Inventors: Ross E. Teggatz, McKinney, TX (US); Wayne T. Chen, Plano, TX (US)

(73) Assignee: TRIUNE IP LLC, Richardson, TX (US)

(21) Appl. No.: 13/489,329

(22) Filed: Jun. 5, 2012

Related U.S. Application Data
(60) Provisional application No. 61/493,499, filed on Jun. 5, 2011.

(51) Int. Cl. G05B 23/02

(52) U.S. Cl. 340/3.44

(57) ABSTRACT

Disclosed are advances in the arts with novel line interface apparatus for monitoring and controlling connections in an electrical system. Exemplary preferred embodiments include smart load ASICs and power control ASICs for monitoring signals at one or more device loads and controlling the monitored signals at the device loads and/or at the main transmission lines. The invention preferably provides the capability to test and monitor electrical interconnections without fully activating the host system.

### PRIORITY ENTITLEMENT

This application is entitled to priority based on Provisional Patent Application Ser. No. 61/493,499 filed on Jun. 5, 2011, which is incorporated herein for all purposes by this reference. This application and the Provisional Patent Application have at least one common inventor.

### TECHNICAL FIELD

The invention relates to providing line interface connections in electrical systems addressing concerns related to system reliability, quality, and safety. More particularly, the invention relates to interfaces for electrical systems that include multi-wire interconnects and/or long transmission lines. In preferred embodiments, the invention relates to the more efficient utilization of energy resources.

### BACKGROUND OF THE INVENTION

For various electrical systems, the available power source(s) may be limited in the amount of current that can be supplied to the system. As such, if a short or soft-short occurs, the loading on the power supply line increases, which in turn reduces the voltage on the line and disables circuitry on the line.

In systems requiring that multiple loads be electrically coupled to one or more main lines, many connection approaches known in the arts may be used. The load lines may be connected off a main line in a linear transmission line configuration, star configuration, or daisy chain configuration, for example. An example familiar in the arts is a system configuration in which load lines are connected off the main line in a two-wire system with a transmission line configuration. A matrix configuration is also known in the arts, in which loads are connected to main lines using a web of load lines arranged in rows and columns. Those familiar with the arts will recognize that various combinations of such configurations may also be used, such as a linear transmission line connected with one or more star configuration, for example. The complexity of the connections may in some instances be very high and the connections may extend over a very large physical area.

Regardless which arrangement of system connections are used, the status of device connections in electrical systems can be outside acceptable limits due to poor installation, environment conditions, external conditions, and/or operational errors. If faulty connections are not detected, the individual device or entire system performance can be affected resulting in potential quality, reliability, and/or safety problems. Due to various challenges, monitoring the status of the interconnect system can be difficult at times. For example, when the connection lines are extremely long, on the order of kilometers, it becomes a challenge to find the locations of faulty connections or loads. Other challenges are environmental conditions that could directly contribute to the increased likelihood of faulty loads due to sharp objects, corrosive materials, extreme temperatures, wind, ice, etc. It would therefore be useful to have the capability to conveniently and reliably monitor and control electrical interfaces within a larger system. One example that demonstrates a need for monitoring a complex interconnect system is in the mining industry, where electronic apparatus is used to control a substantially precisely timed string of detonations. Such a system often uses a multi-wire line interconnect where all the device loads are tapped into the same signals at different points of the interface system. Marginal interconnect status of the tap wires and connections can affect performance of one or more devices. Conventional integrity check methods often fail to detect such marginal conditions. Due to these and other problems and potential problems, an interface system with improved monitoring and control would be useful and advantageous in the arts.

### SUMMARY OF THE INVENTION

In carrying out the principles of the present invention, in accordance with preferred embodiments, the invention provides advances in the arts with novel systems directed to managing the interface of power sources and loads in an electrical system. According to aspects of the invention, preferred embodiments include electrical line interface systems for accommodating multiple loads. Examples of various preferred embodiments of such monitoring systems are described.

According to one aspect of the invention, an example of a preferred embodiment of a line interface system includes smart load circuitry configured to monitor current or voltage levels at one or more loads. Power control circuitry is provided for causing the individual loads to be disconnected from the source upon detection of faults.

According to another aspect of the invention, in an exemplary embodiment the smart load circuitry is preferably implemented as an application-specific integrated circuit (ASIC).

According to another aspect of the invention, in an exemplary embodiment the power control circuitry is preferably implemented as an application-specific integrated circuit (ASIC).

The invention has advantages including but not limited to providing one or more of the following features; improved efficiency, accuracy and safety in monitoring and controlling interconnections in electrical systems, including the ability to test and monitor connections without fully activating the host system. These and other advantageous features and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified schematic diagram illustrating an example of a preferred embodiment of an electrical interface system using an ASIC placed between the load and the main line for the purpose of monitoring and controlling the line; and

FIG. 2 is a simplified schematic diagram depicting an example of a preferred embodiment of an electrical interface system.

References in the detailed description correspond to like references in the various drawings unless otherwise noted. Descriptive and directional terms used in the written description such as front, back, top, bottom, upper, side, et cetera; refer to the drawings themselves as laid out on the paper and not to physical limitations of the invention unless specifically noted. The drawings are not to scale, and some features of embodiments shown and discussed are simplified or amplified for illustrating principles and features, as well as advantages of the invention.

### DESCRIPTION OF PREFERRED EMBODIMENTS

The present patent application is related to U.S. patent application Ser. No. 12/710,307 and, U.S. patent application Ser. No. 13/355,396 which share at least one common inventor with the present application and have a common assignee. Said related applications are hereby incorporated herein for all purposes by this reference.

While the making and using of various exemplary embodiments of the invention are discussed herein, it should be appreciated that the present invention provides inventive concepts which can be embodied in a wide variety of specific contexts. It should be understood that the invention may be practiced with various electronic circuits, systems, system components, host systems, and subsystems without altering the principles of the invention. For purposes of clarity, detailed descriptions of functions, components, and systems familiar to those skilled in the applicable arts are not included. In general, the invention provides electrical interface monitoring and control within an associated host electrical system, providing capabilities for identifying, locating, and switching faulty connections. Preferably, interface monitoring and control may be performed with the system in a test mode, facilitating the making of repairs without necessitating full activation of the host system.

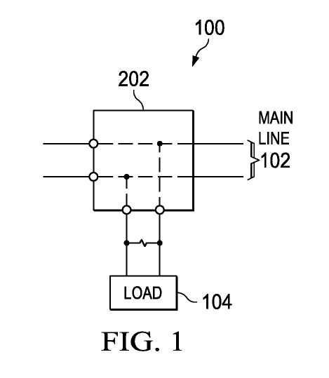

Referring primarily to FIG. 1, an electrical interface system 100 is shown. This system 100 provides a connection between the power line 102 of associated electronics and an electrical load 104. In this particular application, the electronic load 104 may preferably be held in reset during initial power sequencing. For other applications, an alternative current limit or voltage detection may be used to detect a short or soft short as further described herein. For this exemplary system 100, the sequence of operation is preferably as follows. Upon power up, a smart load (SL) circuit 202, preferably implemented as an application-specific integrated circuit (ASIC) monitors the current drawn by the electronic load 104 from the main line 102. This electronic load 104 remains in a low power state. The smart load circuit 202 then measures the current supplied to the electronic load 104. Placed between the main line 102 and device load 104, the purpose of the smart load ASIC 202 is to detect, analyze and report fault conditions associated with the load 104 and/or main line 102. It is within the scope of the invention to use multiple smart load circuits in systems having multiple loads. In the case of a short at a load, e.g., 104, higher currents and/or voltages are drawn from the main line 102. Preferably, the smart load circuit 202 may work in concert with a power control circuit to take activate an alert and/or take other corrective action. Preferably, upon detecting a short, the smart load ASIC 202 then latches off and isolates the faulty load 104 from the main line 102. The smart load ASIC 202 also preferably includes communication functionality that is used to report when a fault is identified and isolated. In this example, if the current detected at the load 104 is larger than a selected threshold level, e.g., 2 mA, then a soft-short is suspected, assuming 28V across the main line wires 102 and a 10 kOhm short. The values herein are given by way of example representative of an implementation of the practice of the invention. The threshold value of the soft short current can be tailored to each system, and be higher or lower than this example.

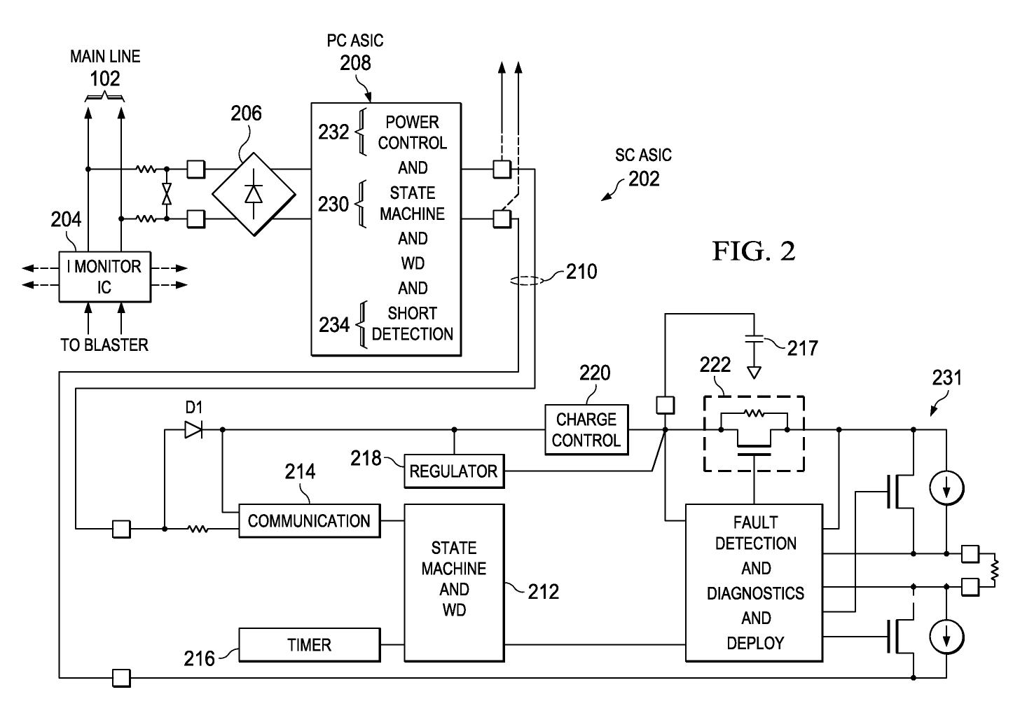

An example of a preferred embodiment of a line interface system 200 is shown in FIG. 2. As shown, a current monitor IC 204, a bridge rectifier 206, a power control (PC) circuit 208, and a smart Load (SL) circuit 202 are provided. The features described below may be implemented using this structure. It should be appreciated that the functions and features described herein may be used in various combinations, and all features do not need to be implemented in a single embodiment in order to implement a system according to the invention. Using a “watchdog” communication interface between the power control circuit (PC) and smart load (SL) circuit, the integrity of the signal line between the PC and SL circuits, in this example ASICs, can be validated. For example, with the PC supplying a signal, e.g., current/voltage/power the line, and measuring the signal at the load with the SL ASIC, digital communication, either bi-directionally, or in only direction may be used to compare the signals sent/received between the two PC circuit and SL circuit. If the differences are determined to be significant, a fault can be reported and the PC and SL circuits may be used to take appropriate action. Appropriate actions could include but would not necessarily be limited to: the PC circuit 208 disconnecting the SL circuit 202 from the main lines 102; the PC circuit 208 communicating to a processor or output device accessible to a user that a fault has occurred; the SL circuit 202 discharging a storage capacitor; the PC circuit indicating the existence of a fault condition through visual, electromagnetic, or other means; or, the PC and/or SL circuit (208, 202) recording the existence of a fault in on-board registers or memory (volatile or non-volatile).

In another example of an implementation of the system of the invention, communication in the system 200 may be monitored constantly. In this case, a constant signal such as a clock signal or communication signal such as a current pulse is used to monitor the connection between the PC and SL circuits. For example, the charge on an energy storage element may be constantly monitored. A constant comparative measurement may be made of the voltage/current/power delivered to the SL ASIC, for comparison with what the PC ASIC is intended to deliver. This check may be done in either the PC or SL circuit.

Again referring primarily to FIG. 2, wires 210 between the PC 208 and SL 202 circuits provide both power and communication signals to and from the PC and SL circuits. The wire can be coax to allow a ground shield and to provide additional protection with ground to protect the inner signal/power line. The wire 210 may alternatively be a twisted pair to allow a common mode of signals. The twisted pair can be placed inside a casing that could be an insulator, or a braided shield to minimize leakage and offer more mechanical protection for the twisted pair.

Preferably, the SL circuit 202 has a blocking device to allow charge on to be stored and not bleed off in case there is a leakage path on the connection between the PC and SL circuits 202, 208. This is shown as diode D1 in the drawing. As shown at 212, a state machine is preferably used to control communication 214 to the PC circuit 208. Monitored faults and diagnostic information may thus be reported to the PC circuit 208 in real time. A timer 216 may be used to control the charging of a storage element 217. A regulator 218 is provided in order to supply power. The storage element 317 may optionally be implemented in the form of a capacitor, super-capacitor, battery, or combination of elements. A charging block 220 is preferably used to limit the amount of current used to charge the storage element(s) 317. This is a safety feature so that if the charging element is inadvertently shorted to another wire or element of the system, inadvertent circuit activation and/or damage is prevented. In preferred embodiments of the system 200, a safety switch 222, such as a FET for example, may be used to keep the energy of the storage element 317 disconnected until specifically commanded by the PC and state machine in the SL. The safe switch 222 can be internal or external to the SL circuit. The signals controlling the safety switch 222 are routed directly thereto, e.g., to the gate of the FET.

As can be seen in FIG. 2, a high-side and a low-side FET 231 are preferably coupled to the output of the circuit 202. The signals controlling the high-side and low-side switch are routed directly to the gate of the FET and are not optimized with any digital logic complier. The system monitors and measures node voltages and/or currents to make sure that all connections are functional. This arrangement ensures that no unexpected shorts are present, both within and outside the device. For example, by measuring voltages across switches so that the switches are not shorted when switches are to be open. Additionally, wire voltages may be measured to make sure that that are not shorted to the energy storage element. Additionally, the system ensures that no unexpected opens exist, both within and outside the device. For example, using low levels of current to test and ensure that the wires are properly connected, voltage is measured on the storage element during charging verifies whether the dV/dt rate is correct to ensure that there is no leakage on the storage element, as well as verifying that the size of storage element is correct. Examples of faults that the system can detect include:

a. High-side FET shorted to battery;

b. High-side FET shorted to ground;

c. High-side FET tested to ensure that the FET can turn on;

d. Low-side FET shorted to battery;

e. Low-side FET shorted to ground;

f. Low-side FET tested to ensure that the FET can turn on;

g. Series resistance between bridge wire is too high or too low;

h. Short across bridge wire.

The system is preferably implemented such that during diagnostics, it may be ensured that inadvertent powering of the loads may be prevented. For example, by providing one or more appropriate switches open within the current path, by ensuring that energy in the storage element is insufficient to power the load, and/or by using only low level current for monitoring and testing the system, conditions that might lead to inadvertently providing full power to the load(s) can be prevented. A communication link is preferably also provided for communicating between the PC circuit 208 and SL circuit 202. Communication can be accomplished using current/voltage levels or current/voltage transitions. It has been found that suitable communication can be achieved using capacitive/AC coupling, direct current, and wired or wireless interfaces.

An exemplary embodiment of a PC ASIC 208 includes a state machine 230 in communication with the SL ASIC 202 and an associated host system. The rectifier 206 connecting the PC circuit 208 with the transmission line 231 allows connection without regard to polarity. Power control 232 and short detection 234 mechanisms are included, limiting the voltage/current/power to the SL circuit 202, providing another level of charging protection to prevent inadvertent full power transmission to the load during testing, preferably monitoring current/voltage/power to the SL ASIC 202 as another diagnostic feature for the health of the system 200. The short detection 234 monitors to detect the presence of any shorts that would be a detriment to the system 200. It should be appreciated that the current levels within the system 200 can be changed over time. For example, initial power up may have different (i.e. lower current) current draw than when the system 200 is fully running (i.e. higher currents). Current detection levels may also change depending upon voltage levels in a system. It should also be understood that the PC circuit 208 output can also be used with multiple SL ASICs in systems having multiple loads. In such implementations, communication capabilities may also be provided for independently addressing each SL circuit in a system. It is contemplated that the PC circuit is adapted for controlling the charging and monitoring of each SL circuit independently, and may output data and/or power.

The current monitor circuit 204 provides functionality similar to that of the PC circuit 208. Using appropriate current monitor circuits 204, a host system may be arranged as mesh, daisy chain, star, and/or branch or other network configurations. One or more of the current monitor ICs could be used in the system, allowing for partitioning a system into subsystems, which may be advantageous in some implementations.

Preferably switches, e.g., 231 are provided in the smart load ASIC 202. Upon detection of a short condition, the switches 231 are caused to open, disconnecting the electronic load 104. In this scenario, when the system 200 is activated upon powering up a host system, the faulty electronic load 104 is prevented from being able to power up, and hence no communication would be possible to this electronic load 104, giving indication which load, potentially among numerous loads in a larger system, has a short or soft-short. In the event no soft-short is detected, then the smart load ASIC's 202 switches 231 remain “on”, and permit the electronic load 104 to be powered in a fully operational state. Preferably, after the lapse of a selected interval of time, the smart load ASIC 202 then switches over to a higher current detection state, for example, greater than 50 mA, although any level may be chosen that is higher than the selected soft-short detection threshold. In this higher current detection state, the smart load ASIC 202 monitors the current supplied to the electronic load 104. If a current condition higher than the selected threshold is detected, then the switches 231 in the smart load ASIC 202 are opened, and communication and power to the electronic load 104 is interrupted. A query of each smart load circuit 202 in a larger system then indicates which load location, if any, e.g., 104, has not communicated, which pinpoints the location of the failure.

Instead of or in addition to monitoring current, the smart load ASIC 202 may also be adapted to monitor voltage in a similar manner in order to detect shorts by measuring the voltage difference on the circuit outputs. In the event the voltage difference is below a selected threshold, this indicates a fault condition and the smart load ASIC 202 switches 231 open in the manner described above. Similarly, a comparison may also be made between the voltages on the input and output nodes. These voltages may be compared single-ended, or differentially to determine whether the difference is significant in comparison to a selected threshold, indicating the existence of a fault. The smart load ASIC 202 may also monitor power to detect the short by measuring voltage or current supplied to the load 104. In the event the power level is too high in comparison with an acceptable threshold, then this indicates a fault condition and the switches 231 open. Once a fault is detected, the smart load ASIC 202 may also indicate the fault condition by providing an electronic alert such as an audio tone and/or visual display.

A host system may be monitored using the smart load ASIC 202 to perform impedance measurements at the outputs of the system over various voltages. It should be noted that soft-short conditions may not be linear and may change significantly with voltage. In alternative embodiments of electrical interface systems, either comparators may be used to measure selected voltage levels or a signal conditioning interface with a look-up table may be used to store data and flag potential system problems. This information may then be transmitted to an operator, and/or to additional control apparatus deployed with the electrical interface system, using suitable wired or wireless communication circuitry. A digital and/or analog protocol may be provided to the smart load ASIC 202 and be adapted for dynamically adjusting a variety of parameters which may include, but are not necessarily limited to current limit level, impedance evaluation over voltage potential, communication validation of a host system, and other various safety and hardware functions. The smart load ASIC 202 may be configured to detect temperature, humidity levels, alkalinity/acidity, or other local conditions in the operating environment. Monitored data relating to these conditions can then be sent to a power control ASIC, an operator, control equipment, or other recipient.

The smart load ASIC 202 and electrical interface system 100 can be used in association with a host system in a variety of ways. Star configurations, multi-star configurations, multiple series configurations, ring configurations, grid configurations, parallel configurations, and other configurations having a power control circuit as a central control unit may be employed, as well as other network configuration schemes. Deploying multiple smart load ASICs 202 and electric interface systems 100 and suitable power control units in combination with series, parallel, star, ring, grid, or other network schemes is also possible within the scope of the invention.

The threshold levels for monitored parameters may be preselected and/or reprogrammed in the smart load ASICs 202 and electric interface system 100 depending upon application specific requirements. Time intervals may also be adjusted either longer or short for soft-short/short circuit detection times. This attribute can preferably be programmed either in the field or at the factory through on-chip memory, external components, pin configurations, and other circuit configuration techniques. Time duration can also be used in conjunction with other events, such as the detection of communication pulse down the line, voltage or current levels, temperature, or other types of events.

The apparatus of the invention provide one or more advantages including but not limited to, electrical interface control efficiency, safety, convenience, and reduced cost. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. An electric line interface system comprising:
a plurality of smart load circuits each adapted for monitoring a signal at a load;
a power control circuit operably coupled with a source, loads, and smart load circuits, the power control circuit being adapted for controlling the transmittal of power signals from the source to the loads;
wherein the power control circuit is equipped for comparing the monitored signals from the smart load circuits to the signals transmitted from the source; and
wherein the power control circuit is configured to take corrective action in the event of a mismatch between the transmitted signal and the signal monitored at a load.

2. An electric line interface system according to claim 1, wherein the power control circuit is further configured to take corrective action by disconnecting one or more loads from the source.

3. An electric line interface system according to claim 1, wherein the power control circuit is further configured to take corrective action by communicating the existence a fault.

4. An electric line interface system according to claim 1, wherein the power control circuit is further configured to take corrective action by communicating the location of a fault.

5. An electric line interface system according to claim 1, wherein the power control circuit is further configured to take corrective action by recording in memory the existence of a fault.

6. An electric line interface system according to claim 1, wherein the power control circuit is further configured to constantly transmit a signal for constant monitoring.

7. An electric line interface system according to claim 1, wherein the power control circuit is further configured to periodically transmit a signal for periodic monitoring.

8. An electric line interface system according to claim 1, wherein at least one of the smart load circuits further comprises a safe switch configured to prevent power transmittal to the load unless expressly overridden by the power control circuit.

9. An electric line interface system according to claim 1, wherein at least one smart load circuit comprises an ASIC.

10. An electric line interface system comprising:
a plurality of smart load ASICs each adapted for monitoring a signal at a load;
a power control ASIC operably coupled with a source, loads, and smart load ASICs, the power control ASIC being adapted for controlling the transmittal of power signals from the source to the loads;
wherein the power control ASIC is equipped for comparing the monitored signals from the smart load ASICs to the signals transmitted from the source; and wherein,
the power control ASIC is configured to take corrective action in the event of a mismatch between the transmitted signal and the signal monitored at a load.

11. An electric line interface system according to claim 10, wherein the power control ASIC is further configured to take corrective action by disconnecting one or more loads from the source.

12. An electric line interface system according to claim 10, wherein the power control ASIC is further configured to take corrective action by communicating the existence a fault.

13. An electric line interface system according to claim 10, wherein the power control ASIC is further configured to take corrective action by communicating the location of a fault.

14. An electric line interface system according to claim 10, wherein the power control ASIC is further configured to take corrective action by recording in memory the existence of a fault.

15. An electric line interface system according to claim 10, wherein the power control ASIC is further configured to constantly transmit a signal for constant monitoring.

16. An electric line interface system according to claim 10, wherein the power control ASIC is further configured to periodically transmit a signal for periodic monitoring.

17. An electric line interface system according to claim 10, wherein at least one of the smart load ASIC further comprises a safe switch configured to prevent power transmittal to the load unless expressly overridden by the power control ASIC.
